(19) United States
(12) Patent Application Publication
(10) Pub. No.: US 2026/0015548 A1
(43) Pub. Date: Jan. 15, 2026

(54) A METHOD FOR PURIFICATION OF LIQUEFIED WASTE PLASTICS USING RECYCLED AQUEOUS STREAM

(71) Applicant: Neste Oyj, Espoo (FI)

(72) Inventors: Ville PAASIKALLIO, Porvoo (FI); Min WANG, Porvoo (FI); Antti PASANEN, Porvoo (FI); Inkeri KAUPPI, Porvoo (FI); Jasmina MAJANEVA, Porvoo (FI)

(73) Assignee: Neste Oyj, Espoo (FI)

(21) Appl. No.: 18/993,182

(22) PCT Filed: Jul. 4, 2023
(86) PCT No.: PCT/FI2023/050426

§ 371 Date: Jan. 10, 2025

(30) Foreign Application Priority Data
Jul. 12, 2022 (EP) 22184303.0
Jul. 12, 2022 (FI) 20225659

(51) Int. Cl. C10G 19/08; B01D 17/04; C10G 19/02; C10G 53/12

(52) U.S. Cl. CPC C10G 19/08; B01D 17/042; C10G 19/02; C10G 53/12; C10G 2300/1003; C10G 2300/201; C10G 2300/4081

(57) ABSTRACT

The present disclosure relates to a method for processing of liquefied waste plastics (LWP). The method includes subjecting a liquefied waste plastic-based feedstock to heat treatment (HT processing) in an aqueous solution containing alkali metal hydroxide and/or alkaline earth metal hydroxide to form a heat treated effluent, transferring the heat treated effluent to a separator, subjecting the heat treated effluent to phase separation to isolate at least an oil phase including treated LWP and an aqueous phase including contaminated material, and recycling at least a part of the aqueous phase back to the HT processing.

### DESCRIPTION

### Technical Field

The present invention relates to improvements in waste water handling in the processing of liquefied waste plastics, more particularly to improvements in handling a contaminated aqueous phase obtained after heat treatment of liquefied waste plastics.

### Background of the Invention

The purification of liquefied waste plastics (LWP) to yield more valuable (pure) substances and the conversion of liquefied waste plastics (LWP) into more valuable material have been studied for several years.

LWP is typically produced by pyrolysis or hydrothermal liquefaction (HTL) of waste plastics. Depending on the source of the waste plastics and on liquefaction processing conditions, LWP has variable levels of impurities. Typical impurity components are chlorine, nitrogen, sulphur and oxygen of which corrosive chlorine is particularly problematic for refinery/petrochemical processes. These impurities originate from the waste plastic material, such as post-consumer waste plastics (recycled consumer plastics), which have been identified as the most potential large-scale source for plastics waste. Similarly, bromine-containing impurities may be contained mainly in industry-derived waste plastics (e.g. originating from flame retardants).

No matter whether the LWP is merely subjected to common refinery processing (e.g. fractionation) or is forwarded to a typical petrochemical conversion process (e.g. steam cracking), the LWP-based feedstock needs to meet the impurity levels for these processes so as to avoid deterioration of the facility, such as corrosion of reactors or catalyst poisoning.

In addition to refining, chemical recycling of LWP back to plastic (or to monomers) is an interesting option which has sparked significant interest in the petrochemical industry during the last years. The attention has been further boosted by a new waste directive and the EU plastic strategy that both set ambitious targets for the recycling of waste plastics.

In view of the increasing interest in adding LWP to the value chain, several options for purifying LWP so as to make it more suitable for conventional oil refinery processing have been developed.

WO 2018/10443 A1 discloses a steam cracking process comprising pre-treatment of a mainly paraffinic hydrocarbon feed, such as hydrowax, hydrotreated vacuum gas oil, pyrolysis oil from waste plastics, gasoil or slackwax. Pre-treatment is carried out using a solvent extraction so as to reduce fouling components, such as polycyclic aromatics and resins. Such solvent extraction techniques may have poor removal efficiency for certain contaminants in the LWP and furthermore result in significant amounts of contaminated extraction material, which requires work-up or disposal.

US 2016/0264874 A1 discloses a process for upgrading waste plastics, comprising a pyrolysis step, a hydroprocessing step, a polishing step and a steam cracking step in this order. This process consumes large amounts of hydrogen which is usually produced from fossil sources. The process is thus not favourable in view of sustainability.

FI 128848 B discloses a process for converting LWP into a steam cracker feed by heat treating the LWP with an aqueous medium having a pH of at least 7, followed by hydrotreatment of the treated LWP material. Purification using an aqueous medium results in large amounts of contaminated water since the aqueous medium is usually employed in the same order of magnitude as the LWP-based feedstock.

US 2014/0303421 A1 discloses a method for conditioning synthetic crude oils with a caustic process solution. US 2014/0303421 A1 employs slightly elevated temperature together with a caustic solution having a pH of about 8 to 10. The conditioning treatment of US 2014/0303421 A1 is a washing treatment and does not qualify as a HT processing of the present invention.

FI 128069 B relates to a method of purifying e.g. recycled material, such as LWP, comprising a purification step and a hydrotreatment step, wherein the purification step may be carried out in the presence of an aqueous solution comprising an alkaline metal hydroxide. This procedure achieves good removal efficiency of chlorine impurities but still results in large amounts of waste water.

### SUMMARY OF INVENTION

The above prior art approaches employ various purification procedures for LWP, each having certain drawbacks regarding sustainability.

The present invention was made in view of the above-mentioned problems and it is an object of the present invention to provide an improvement in the process of upgrading LWP, in particular an improvement in the processing of a contaminated aqueous phase emerging from treatment of an LWP-based feedstock with an aqueous solution comprising an alkali metal hydroxide and/or alkaline earth metal hydroxide. More specifically, the present invention aims at improving the utilisation efficiency of an aqueous alkaline solution.

This problem of providing an improved process is solved by a method of set forth in any one of the claims.

In brief, the present invention relates to one or more of the following items:

1. Method for processing of liquefied waste plastics (LWP), said method comprising the steps of:
subjecting a liquefied waste plastic-based feedstock to heat treatment (HT processing) in an aqueous solution comprising alkali metal hydroxide and/or alkaline earth metal hydroxide to form a heat treated effluent,
transferring the heat treated effluent to a separator,
subjecting said heat treated effluent to phase separation to isolate at least an oil phase comprising treated LWP and an aqueous phase comprising contaminated material, and
recycling at least a part of the aqueous phase back to the HT processing step.

2. The method according to item 1, comprising
subjecting the aqueous phase to a treatment to form an organics-rich stream and an organics-depleted stream, wherein the organic-depleted stream is recycled back to the HT processing step.

3. The method according to item 1 or 2, wherein 1 wt.-% to 90 wt.-% of the aqueous phase is recycled back to the HT processing step.

4. The method according to item 3, wherein 5 wt.-% to 85 wt.-%, preferably 10 wt.-% to 80 wt.-%, 15 wt.-% to 75 wt.-%, 20 wt.-% to 70 wt.-%, 25 wt.-% to 70 wt.-%, 30 wt.-% to 65 wt.-%, or 40 wt.-% to 60 wt.-% of the aqueous phase is recycled back to the HT processing step.

5. The method according to any one of the preceding items, the method further comprising:
subjecting part of the aqueous phase to evaporation to provide an evaporation residue and a waste water evaporate.

6. The method according to item 5, further comprising a step of forwarding the waste water evaporate to waste water treatment and/or forwarding the evaporation residue to incineration.

7. The method according to any one of the preceding items, further comprising adding fresh alkali metal hydroxide solution and/or alkaline earth metal hydroxide solution to the recycled aqueous phase to form a combined stream before feeding it back to the HT processing.

8. The method according to any one of the preceding items, wherein the aqueous solution comprising the alkali metal hydroxide and/or alkaline earth metal hydroxide which is subjected to heat treatment (HT processing) together with the liquefied waste plastic (LWP)-based feedstock contains the alkali metal hydroxide and/or alkaline earth metal hydroxide in an amount in the range of from 0.5 wt.-% to 10.0 wt.-%, such as from 1.0 wt.-% to 6.0 wt.-%, or 1.5 wt.-% to 4.0 wt.-%.

9. The method according to any one of the preceding items, wherein mixing ratio (water-oil-ratio) between the aqueous solution and the LWP-based feedstock in the heat treatment step is in the range of from 0.1 to 1.4 by weight, preferably in the range of 0.2 to 1.0, such as 0.2 to 0.7.

10. The method according to any one of the preceding items, wherein the phase separation is carried out as a continuous process.

11. The method according to any one of the preceding items, wherein both the HT processing and the phase separation are carried out as a continuous process.

12. The method according to any one of the preceding items, wherein the phase separation is carried out at a temperature in the range of from 40° C. to 150° C., such as in the range from 50° C. to 150° C., or in the range from 60° C. to 150° C.

13. The method according to any one of the preceding items, comprising
subjecting the aqueous phase to a process comprising filtration to provide a retentate enriched in total organic carbon (TOC) and a permeate depleted in total organic carbon (TOC) and comprising alkali metal hydroxide and/or alkaline earth metal hydroxide, and
recycling the permeate, after optional further purification, back to the HT processing step as the at least part of the aqueous phase.

14. The method according to item 13, wherein the filtration comprises membrane filtration.

15. The method according to items 13 or 14, wherein the filtration is conducted in multiple filtration steps, such as mechanical filtration (macrofiltration) followed by membrane filtration.

16. The method according to any one of items 13 to 15, wherein the filtration comprises membrane filtration and the membrane filtration is carried out at a temperature in the range of 20° C. to 100° C., preferably in the range of 30° C. to 90° C., 40° C. to 80° C., or 50° C. to 70° C.

17. The method according to any one of items 13 to 17, further comprising:
subjecting the retentate enriched in total organic carbon to evaporation to provide an retentate evaporation residue and a retentate waste water evaporate.

18. The method according to item 17, further comprising combusting the retentate evaporation residue.

19. The method according to any one of the preceding items, wherein the pH of the aqueous phase is adjusted to pH 9 or more, preferably pH 10 or more, pH 11 or more, or pH 11.5 or more, before recycling it back to the HT processing step.

20. The method according to any one of the preceding items, wherein the part of the aqueous phase is recycled back to the HT processing without being post-treated.

21. The method according to any one of the preceding items, wherein the step of providing liquefied waste plastics (LWP)-based feedstock includes a step of liquefying waste plastics, preferably by thermal degradation of waste plastics, such as pyrolysis or hydrothermal liquefaction or similar process steps.

22. The method according to any one of the preceding items, wherein the aqueous solution comprising the alkali metal hydroxide and/or alkaline earth metal hydroxide is an aqueous solution comprising an alkali metal hydroxide, preferably an aqueous solution comprising NaOH.

23. The method according to any one of the preceding items, wherein the aqueous solution comprising the alkali metal hydroxide and/or alkaline earth metal hydroxide comprises at least 50 wt.-% water, preferably at least 70 wt.-% water, more preferably at least 85 wt.-% water, at least 90 wt.-% water or at least 95 wt.-% water.

24. The method according to any one of the preceding items, wherein the aqueous solution comprising the alkali metal hydroxide and/or alkaline earth metal hydroxide has a pH of 8.0 or more, preferably 9.0 or more, 10.0 or more, 11.0 or more, 12.0 or more, or 13.0 or more, such as in the range of from 8.0 to 14.0, 9.0 to 13.9, 10.0 to 13.9, 11.0 to 13.9, 12.0 to 13.9, or 13.0 to 13.9.

25. The method according to any one of the preceding items, wherein the HT processing is carried out at a temperature of 150° C. or more, preferably 190° C. or more.

26. The method according to any one of the preceding items, wherein HT processing is carried out at a temperature of 200° C. or more, such as 210° C. or more, 220° C. or more, 240° C. or more or 260° C. or more.

27. The method according to any one of the preceding items, wherein HT processing is carried out at a temperature of 450° C. or less, preferably 400° C. or less, 350° C. or less, 320° C. or less, or 300° C. or less.

28. The method according to any one of the preceding items, wherein HT processing is carried out at a temperature in the range of 200° C. to 350° C., preferably 220° C. to 330° C., 240° C. to 320° C., or 260° C. to 300° C.

29. The method according to any one of the preceding items, wherein the liquefied waste plastics (LWP)-based feedstock has a 5% boiling point of 25° C. or more, preferably 30° C. or more, or 35° C. or more, such as in the range of from 25° C. to 120° C., in the range of from 25° C. to 100° C., in the range of 30° C. to 90° C., or in the range of from 35° C. to 80° C.

30. The method according to any one of the preceding items, wherein the liquefied waste plastics (LWP)-based feedstock has a 95% boiling point of 700° C. or less, preferably 650° C. or less, 600° C. or less, or 550° C. or less, such as in the range of from 180° C. to 700° C., 250° C. to 700° C., 300° C. to 650° C., 350° C. to 600° C., 380° C. to 500° C., or 400° C. to 500° C.

31. The method according to any one of the preceding items, wherein the step of providing the LWP-based feedstock includes a step of liquefying sorted waste plastics, and the method further comprises a step of sorting waste plastics to provide sorted waste plastics, preferably removing at least 50 wt.-%, more preferably at least 55 wt.-%, at least 60 wt.-%, at least 65 wt.-%, at least 70 wt.-%, at least 75 wt.-%, at least 80 wt.-%, or at least 85 wt.-% of chlorine-containing waste plastics, such as polyvinyl chloride, PVC (relative to the original content of chlorine-containing waste plastic, such as PVC, in the waste plastics).

32. The method according to any one of the preceding items, wherein the LWP-based feedstock has a density, as measured at 15° C. in the range of from 0.780 to 0.950 kg/l, such as in the range of from 0.780 to 0.900 kg/l, or in the range of from 0.780 to 0.850 kg/l.

33. The method according to any one of the preceding items, wherein the LWP-based feedstock has an olefins content of 5 wt.-% or more, such as 10 wt.-% or more, 15 wt.-% or more, 20 wt.-% or more, 30 wt.-% or more, 40 wt.-% or more, or 50 wt.-% or more.

34. The method according to any one of the preceding items, wherein the LWP-based feedstock has an olefins content of 85 wt.-% or less, such as 80 wt.-% or less, 70 wt.-% or less, or 65 wt.-% or less.

35. The method according to any one of the preceding items, wherein the chlorine content of the LWP-based feedstock is in the range of from 1 wt.-ppm to 4000 wt.-ppm, such as 100 wt.-ppm to 4000 wt.-ppm, or 300 wt.-ppm to 4000 wt.-ppm.

36. The method according to any one of the preceding items, wherein no hydrogen is added in the HT processing and/or no hydrotreating catalyst is present.

37. The method according to any one of the preceding items, wherein the ratio between the bromine number (BN2) of the treated LWP and the bromine number (BN1) of the LWP-based feedstock, BN2/BN1 is 0.90 or more, preferably 0.95 or more, such as in the range of from 0.90 to 1.10, 0.90 to 1.02 or 0.95 to 1.00.

### BRIEF DESCRIPTION OF THE DRAWING

FIG. 1 is a schematic flow diagram of an embodiment of the method of the present invention including (optional) purification process of the aqueous phase (used alkali)

### DETAILED DESCRIPTION OF THE INVENTION

The present invention relates to an improvement in the method for upgrading liquefied waste plastics and more specifically to recycling of alkali metal or alkaline earth metal back to a purification process of the LWP-based feedstock.

An LWP-based feedstock, such as a pyrolysis product of collected consumer plastics, contains large and varying amounts of contaminants which would be detrimental in downstream processes. Such contaminants include, among others, halogens (mainly chlorine) originating from halogenated plastics (such as PVC and PTFE), sulphur originating from cross-linking agents of rubbery polymers (e.g. in end-of-life tires) and metals or metalloids (e.g. Si, Al) contaminants originating from composite materials and additives (e.g. films coated with metals or metal compounds, end-of-life tires, or plastics processing aids). These contaminants may be present in elemental form, in ionic form, or as a part of organic or inorganic compounds.

These impurities should be removed before the LWP is subjected to further processing. The present invention focusses on a method of removing such impurities (or contaminants) by treatment of an LWP-based feedstock with an aqueous solution comprising alkali metal hydroxide and/or alkaline earth metal hydroxide at elevated temperature (also referred to as heat treatment (HT) processing in the following). HT processing may also be referred to as “reactive extraction”. The HT processing results in large amounts of contaminated water (also referred to as aqueous phase). The present invention provides an improvement of handling the contaminated water in an efficient manner so as to reduce costs and environmental impact.

The present invention specifically focusses on possibilities of improving separation of the purified LWP material (treated LWP) and the aqueous phase emerging from the HT processing of LWP-based feedstock and on possibilities of recycling the alkali metal hydroxide and/or alkaline earth metal hydroxide still contained in the aqueous phase back into the process.

In the context of the present invention, liquefied waste plastics (LWP) means a product effluent from liquefaction process comprising at least depolymerising waste plastics. LWP is thus a material which is obtainable by depolymerizing waste plastics. LWP may also be referred to as polymer waste-based oils. The waste plastics which forms the basis for the LWP may be pure (clean) waste plastics. On the other hand, it may be more favourable to employ non-purified waste plastics, such as waste plastics sorted out from municipal waste and still containing other (non-plastic) components, preferably less than 15 wt.-% non-plastic components, or less than 10 wt.-% non-plastic components. The LWP is preferably formed from polyolefin-rich waste plastic, such as waste plastic having a polyolefins content of 50 wt.-% to 100 wt.-%, preferably at least 60 wt.-%, at least 70 wt.-%, at least 80 wt.-%, or at least 90 wt.-%. The content of polyolefins may be determined using any commonly known method, such as

DSC, melting enthalpy, FT-IR, or NMR, in particular solid state NMR, which are usual in laboratories.

An LWP-based feedstock is similarly a feedstock which is based on LWP, i.e. it contains at least LWP, preferably at least 50 wt.-% LWP, such as at least 60 wt.-% LWP, at least 70 wt.-% LWP, at least 80 wt.-% LWP, or at least 90 wt.-% LWP. The LWP-based feedstock may consist of LWP.

The waste plastics may be derived from any source, such as (recycled or collected) consumer plastics, (recycled or collected) industrial plastics or (recycled or collected) end-life-tires (ELT). In particular, the term waste plastics refers to an organic polymer material which is no longer fit for its use or which has been disposed of for any other reason. Waste plastics may more specifically refer to end-life tires, collected consumer plastics (consumer plastics referring to any organic polymer material in consumer goods, even if not having “plastic” properties as such), collected industrial polymer waste. In the sense of the present invention, the term waste plastics or “polymer” in general does not encompass purely inorganic materials (which are otherwise sometimes referred to as inorganic polymers). Polymers in the waste plastics may be of natural and/or synthetic origin and may be based on renewable and/or fossil raw material.

The liquefaction process is typically carried out at elevated temperature, and preferably under non-oxidative conditions. The liquefaction process may be carried out at elevated pressure. The liquefaction process may be carried out in the presence of a catalyst. The effluent from the liquefaction process may be employed as the liquefied waste plastic-based feedstock as such or may be subjected to fractionation (or separation) to provide a fraction (or separated liquid) of the effluent as the liquefied waste plastic-based feedstock. For example, the LWP-based feedstock may be a hydrothermal liquefaction oil or a fraction thereof. Similarly, multiple fractionations may be carried out. In addition, two or more liquefaction process effluents and/or fractions thereof may be combined to give the LWP-based feedstock. These effluents and/or fractions may have the same or similar boiling range or may have different boiling ranges. In this context, fractionation refers to fractional distillation and/or fractional evaporation.

In addition to liquid (NTP) hydrocarbons, i.e. hydrocarbons being liquid at normal temperature and pressure (NTP; 20° C., 101.325 kPa absolute), typical product effluents from liquefaction processes comprise gaseous (NTP) hydrocarbons, and hydrocarbons that are waxy or solid at NTP but become liquids upon heating, for example upon heating to 80° C.

In the context of the present disclosure, depolymerizing waste plastic means decomposing or degrading the polymer backbones of the waste plastic, typically at least thermally, to the extent yielding polymer and/or oligomer species of smaller molecular weight compared to the starting waste plastic, but still comprising at least liquid (NTP) hydrocarbons. In other words, as used herein, the liquefied waste plastic does not cover plastics in liquid form obtained merely by melting or by dissolving into a solvent, as these do not involve sufficient cleavage of the polymer backbones, nor waste plastics depolymerized completely to the monomer-level and thus being of gaseous (NTP) form. Depolymerizing waste plastics may also involve cleavage of covalently bound heteroatoms such as O, S, and N from optionally present heteroatom-containing compounds.

Initially the waste plastics, or each waste plastics species in mixed waste plastics, to be subjected to liquefaction, is usually in solid state, typically having a melting point in the range of 100° C. or more as measured by DSC as described by Larsen et al. (“Determining the PE fraction in recycled PP”, Polymer testing, vol. 96, April 2021, 107058). However, the waste plastics, or each waste plastics species, may be melted before and/or during the depolymerisation.

Solid waste plastics may contain various further components such as additives, reinforcing materials, etc., including fillers, pigments, printing inks, flame retardants, stabilizers, antioxidants, plasticizers, lubricants, labels, metals, paper, cardboard, cellulosic fibres, fibre-glass, even sand or other dirt. Some of the further components may be removed, if so desired, from the solid waste plastics, from melted waste plastic, and/or from liquefied waste plastic using commonly known methods.

Preferably, the (solid) waste plastics to be subjected to the liquefaction process (depolymerisation), and thus being the base material of the LWP-based feedstock, has an oxygen content of 15 wt.-% or less, preferably 10 wt.-% or less, more preferably 5 wt.-% or less, of the total weight of the (solid) waste plastics. The oxygen content may be 0 wt.-% and may preferably be in the range of 0 wt.-% to 15 wt.-% or 0 wt.-% to 10 wt. %. Oxygen content in wt.-% can be determined by difference using the formula 100 wt.-%−(CHN content+ash content), wherein CHN content refers to combined content of carbon, hydrogen and nitrogen, as determined in accordance with ASTM D5291, and ash content refers to ash content as determined in accordance with ASTM D482/EN15403.

In the present disclosure, when reference is made to a standard, the latest revision available on Jan. 31, 2022 shall be meant, unless stated to the contrary. Furthermore, all embodiments (such as all preferred values and/or ranges within the embodiments) of the present invention may be combined with each other to give new (preferred) embodiments, unless explicitly specified otherwise or unless such a combination would result in a contradiction.

The LWP preferably comprises primarily hydrocarbons, typically more than 50 wt.-% based on the total weight of the LWP. Typically the LWP comprises two or more hydrocarbon species selected from paraffins, olefins, naphthenes and aromatics. The composition of the LWP may vary depending e.g. on the composition of the waste plastics, liquefaction process type and conditions, and any additional treatments. Further, the assortment of various species of waste plastics and impurities associated with collected waste may result in a presence of impurities including silicon, sulphur, nitrogen, halogens and oxygen related substances in various quantities in the LWP.

The LWP-based feedstock of the present invention is derived from (crude) LWP and may, for example, be crude LWP (i.e. the liquid fraction directly emerging from the liquefaction process), pre-purified LWP, or a fraction of one of the afore-mentioned.

Preferably, the LWP-based feedstock specifically refers to an oil or an oil-like product obtainable from liquefaction using non-oxidative thermal or thermocatalytic depolymerisation of (solid) waste plastics (followed by optional subsequent fractionation and/or purification). In other words, the LWP-based feedstock may also be referred to as “depolymerized polymer waste” or “liquefied polymer waste”.

The method of liquefaction is not particularly limited as long as it is a depolymerisation process and one may mention thermal depolymerisation processes, such as pyrolysis (e.g. fast pyrolysis) of waste plastics, or hydrothermal liquefaction of waste plastics.

The term “hydrothermal liquefaction” (HTL) refers to a thermal depolymerisation process to convert a carbon-containing feedstock into crude-like oil under moderate temperature and high pressure using subcritical or supercritical water. The term “pyrolysis” refers to thermal decomposition of materials at elevated temperatures in a non-oxidative atmosphere. The term “fast pyrolysis” refers to thermochemical decomposition of carbon containing feedstock through rapid heating in the absence of oxygen.

Further, in the present invention, the term “pH” refers to the pH value measured at (or converted to a value corresponding to measurement at) 20° C. The pH can be measured in accordance with Finnish standard SFS 3021.

The term “mechanical filtration” (also referred to as macrofiltration) relates to filtration with a pore size of from 0.5 to 40 μm, preferably 1 to 20 μm, such as 2 to 20 μm. Furthermore, microfiltration relates to filtration with a pore size of from 0.1-5.0 μm, and ultrafiltration relates to filtration with a pore size of from 20 nm-0.1 μm. The term “membrane filtration” or “reverse osmosis” refers to filtration with a membrane having small pore size such that it can separate at least water from organic components of certain size. Such membranes are commonly designated by their molecular weight cut-off (rejection size) rather than by pore size. For example, a membrane having a cut-off of 200 Dalton usually relates to filtration with a pore size of from 0.05 nanometres to 0.1 nanometres.

In brief, the present invention relates to a method for processing of liquefied waste plastics (LWP), said method comprising the steps of subjecting a liquefied waste plastic-based feedstock to heat treatment (HT processing) in an aqueous solution comprising alkali metal hydroxide and/or alkaline earth metal hydroxide to form a heat treated effluent, transferring the heat treated effluent to a separator, and subjecting said heat treated effluent to phase separation to isolate at least an oil phase comprising treated LWP and an aqueous phase comprising contaminated material, and recycling at least a part of the aqueous phase back to the HT processing step. The method of the present invention produces treated LWP (after heat treatment and phase separation), also referred to as treated LWP material.

By recycling at least part of the aqueous phase, the overall consumption of the metal hydroxide (alkali/base) can be reduced and at the same time the amount to be disposed can be reduced. The fresh water consumption can be reduced as well. Since the recycling of the at least part of the aqueous phase does not require excessive efforts, the process of the present invention thus has improved sustainability. In addition, the base may be added in excess in the HT processing step (or higher excess than one would otherwise use), which can increase the purification efficiency in the HT processing while avoiding too much loss of base (metal hydroxide).

The method may comprise subjecting the aqueous phase to a treatment to form an organics-rich stream and an organics-depleted stream, wherein the organic-depleted stream is recycled back to the HT processing step as the at least part of the aqueous phase.

Removal or reduction of organic contaminants contained in the aqueous phase (comprising contaminated material, i.e. after phase separation) may be favourable because such (residual) organic contaminants may interfere with mass transfer (and/or solubility) of impurities in the HT processing. In other words, recycling such contaminants back might lead to reduced purification efficiency in HT processing, especially when they accumulate in the course of recycling. On the other hand, it may even be favourable to carry out recycling of the aqueous phase without any post-treatment (more specifically without purification of the aqueous phase). This provides a simplified process and may even minimize product loss since organic (product) material contained in the aqueous phase is re-introduced into the process together with the recycled part of the aqueous phase. Since fresh water and/or fresh metal hydroxide is usually added to the aqueous phase before recycling to give the aqueous solution, excessive accumulation of impurities in the aqueous phase can be avoided.

The method may specifically comprise subjecting the aqueous phase to a process comprising filtration to provide a retentate enriched in total organic carbon (TOC) (an organics-rich stream) and a permeate depleted in total organic carbon (TOC) (an organics-depleted stream), and recycling the permeate, after optional further purification, back to the HT processing step (as at least part of the aqueous phase). The permeate will usually comprise water together with alkali metal hydroxide and/or alkaline earth metal hydroxide contained in the aqueous phase. Filtration is a simple and efficient process and it has surprisingly been found that it is efficient in removing organic contaminants. As a matter of course, both an organics-depleted stream and a (part of the) non-treated aqueous phase may be recycled back as the at least part of the aqueous phase.

The filtration preferably comprises membrane filtration. The membrane filtration is preferably a pressure-driven process. Membrane filtration can efficiently remove dissolved organic contaminants. Membrane filtration is also sometimes referred to as reverse osmosis and membranes to be used in the present invention preferably have a cut-off size in the range of 50-400 Dalton, preferably 100 to 300 Dalton, such as 150 to 250 Dalton. Membrane filtration may be single-run or multi-run filtration but is preferably a single-run membrane filtration (the overall process comprises exactly one membrane filtration), since this produces less retentate (which requires more severe workup).

The filtration may be conducted in multiple filtration steps, such as mechanical filtration (macrofiltration) followed by membrane filtration. Multi-step filtration may be favourable since mechanical filtration before membrane filtration can avoid clogging and/or damage of the membrane. On the other hand, it may be favourable to include only macrofiltration before membrane filtration, rather than employing an additional ultrafiltration and/or microfiltration, since such additional steps again lead to an increased amount of retentate. In particular, the inventors of the present invention found that even membrane filtration alone (preferably preceded by a mechanical filtration for protecting the membrane) results in an aqueous material which is already rather pure and can be recycled back into the HT processing step without further restriction. Otherwise (i.e. if the aqueous phase or the membrane filtration permeate needed to be forwarded to waste water treatment), the additional treatment (purification) would usually be done by evaporation, which produces a highly contaminated residue that was conventionally regarded as being waste, more specifically a very problematic waste to be disposed.

Preferably, the filtration comprises membrane filtration and the membrane filtration is carried out at a temperature in the range of 20° C. to 100° C., preferably in the range of 30° C. to 90° C., 40° C. to 80° C., or 50° C. to 70° C. Membrane filtration at elevated temperature has been found to be particularly effective.

In another embodiment, the method may further comprises subjecting at least part of the aqueous phase (more specifically, at least a part of the aqueous phase that is not recycled to the HT processing step) to evaporation to provide an evaporation residue and a waste water evaporate. Similarly, (a part of) the permeate of the membrane filtration (which is not recycled) may be subjected to evaporation to provide an evaporation residue and a waste water evaporate.

The waste water evaporate usually has low residual amounts of TOC and may be forwarded to further (conventional) waste water treatment. The waste water evaporate (optionally after having been subjected to waste water treatment) may be used as a fresh water addition (feed) in the method of the present invention. A part (or all of) of the evaporation residue may be combusted (incinerated). Since the base (and similarly metal compounds resulting therefrom) is usually not evaporated, the combustion will usually provide an ash comprising a compound of alkali metal and/or alkaline earth metal. It can be assumed that the compound will usually be or comprise an oxide, hydroxide or carbonate.

The retentate enriched in total organic carbon is a highly contaminated aqueous phase. It may be subjected to evaporation as well or may be directly combusted. If evaporation is carried out, the retentate evaporation residue usually contains water, inorganic salts, organic salts and organic molecules. This retentate evaporation residue may be combusted, again providing an ash which comprises a compound of alkali metal and/or alkaline earth metal. This procedure allows conversion of the retentate into a material of (quite) defined composition (the retentate evaporation residue), thus reducing its volume, while the material is ready for disposal or further workup (after optional combustion).

The evaporation (any one of the aforementioned individually or together) may be a single stage evaporation or may preferably comprise multiple evaporators in series so as to provide a waste water evaporate (and/or retentate waste water evaporate) of improved purity.

The compound of alkali metal and/or alkaline earth metal which is contained in evaporation residue may be converted into an alkali metal hydroxide and/or alkaline earth metal hydroxide. Thus, even a material (ash) which otherwise requires disposal can still be used. In case the evaporation residue (of aqueous phase, permeate and/or retentate) is combusted, the ash is the major route through which the alkali metal/alkaline earth metal is lost. In other words, almost full recycling of the alkali metal or alkaline earth metal is possible.

Recycling the alkali metal/alkaline earth metal contained in the ash can be accomplished by any known means. For example, in case the compound is e.g. an oxide or otherwise soluble in water, extracting the compound of alkali metal/alkaline earth metal may be achieved by adding water to the ash, followed by solid-liquid separation (e.g. filtration). For example, in case the compound is or comprises an alkali metal carbonate, the method may further comprise adding an aqueous calcium hydroxide solution to the alkali metal carbonate to give a solution comprising alkali metal hydroxide and a precipitate comprising calcium carbonate, separating the solution comprising alkali metal hydroxide from the precipitate comprising calcium and recycling the separated solution comprising alkali metal hydroxide back to the HT processing. In this procedure, and oxide, if present, is converted to hydroxide by contacting with water. The alkali metal carbonate is soluble (and thus can be separated from remaining ash) and is thereafter converted to hydroxide while rather pure CaCO₃ is precipitated. This CaCO₃ can then be used for other processes. When the compound is or comprises an alkaline earth metal carbonate, the method may further comprise calcining the alkaline earth metal carbonate to give an alkaline earth metal oxide and recycling the alkaline earth metal oxide, preferably after addition of water to give an aqueous solution comprising an alkaline earth metal hydroxide (and separation from the ash), back to the HT processing. An alkaline earth metal oxide, if present, is converted to hydroxide by contacting with water. The carbonate (e.g. calcium carbonate), on the other hand, may be insoluble and thus should be converted to be separated from remainder of ash.

The evaporated water (waste water evaporate and/or retentate waste water evaporate) may be fed back into the process as well. Since most water-soluble impurities (e.g. organic acids/acid salts) are thus removed from the waste water, feeding it back will hardly cause unwanted accumulation of the organic compounds or other impurities that would impair HT processing efficiency.

The method preferably further comprises adding fresh alkali metal hydroxide and/or alkaline earth metal hydroxide to the aqueous phase before recycling it to the HT process. The fresh hydroxide is preferably added as a concentrated aqueous solution, giving well-defined conditions for further workup. The fresh hydroxide may, for example, be added to recycled membrane filtration permeate and/or to recycled untreated aqueous phase (or part thereof). Thus, pH of the aqueous phase to be recycled can be adjusted to desired level for HT processing. Preferably, the pH of the aqueous phase is adjusted to pH 9 or more, preferably pH 10 or more, such as in the range of from 10.0 to 14.0; 11.0 to 14.0, 11.5 to 13.9, or 12.0 to 13.8. These pH ranges (as well as those mentioned for HT processing as such) are particularly preferable for recycling back to the HT processing.

The addition of fresh alkali (i.e. adjustment of the pH) is preferably done before feeding the at least part of the aqueous phase back to the HT processing step. Alternatively, though not preferred, the at least part of the aqueous phase and the fresh alkali (and optionally fresh water) may be fed to the HT processing step as separate feeds (and thus combined in the course of the HT processing).

The method may further comprise adding fresh alkali metal hydroxide and/or alkaline earth metal hydroxide to the aqueous phase before membrane filtration, if applied, to adjust the pH of the aqueous phase to be subjected to membrane filtration. Preferably, the pH is adjusted to pH 9 or more, preferably pH 10 or more, such as in the range of from 10.0 to 14.0; 11.0 to 14.0, or 11.0 to 13.8. This may further improve membrane filtration efficiency.)

In the present invention, it is favourable that 1 wt.-% to 90 wt.-% of the aqueous phase be recycled back to the HT processing step. Such a recycling rate is favourable for both an organics-depleted aqueous phase and a non-post-treated aqueous phase. The percentage (recycling rate) of the recycled aqueous phase is calculated as the mass of recycled material (originating from the aqueous phase, i.e. excluding addition of fresh water and fresh alkali, if added) divided by the total mass of the aqueous phase (directly) after phase separation. The recycling rate may particularly be in the range of 5 wt.-% to 85 wt.-%, preferably 10 wt.-% to 80 wt.-%, 15 wt.-% to 75 wt.-%, 20 wt.-% to 70 wt.-%, 25 wt.-% to 70 wt.-%, 30 wt.-% to 70 wt.-%, or 40 wt.-% to 65 wt.-%.

The aqueous solution comprising the alkali metal hydroxide and/or alkaline earth metal hydroxide which is subjected to heat treatment (HT processing) together with the liquefied waste plastic (LWP)-based feedstock preferably contains the alkali metal hydroxide and/or alkaline earth metal hydroxide in an amount in the range of from 0.5 wt.-% to 10.0 wt.-%, such as from 1.0 wt.-% to 6.0 wt.-%, or 1.5 w.-% to 4.0 wt.-%. The metal hydroxide concentration (and water-to-oil ratio) may be adjusted in accordance with need, usually based on the properties (such as acidity) of LWP-based feedstock. High enough an amount of metal hydroxide ensures that impurities are effectively removed.

Within the above-mentioned concentration ranges, good impurity removal efficiency can be achieved in the HT processing with reasonable amounts of water (water-oil-ratio).

The alkali metal hydroxide and/or alkaline earth metal hydroxide is preferably selected from the group consisting of KOH, NaOH, LiOH, Ca(OH)₂, Mg(OH)₂, RbOH, Sr(OH)₂ and Ba(OH)₂, particularly preferably NaOH.

The aqueous solution comprising the alkali metal hydroxide and/or alkaline earth metal hydroxide is particularly preferably an aqueous solution comprising an alkali metal hydroxide, preferably an aqueous solution comprising NaOH. Alkali metal hydroxides allow simple recycling and workup, since virtually all (inorganic) alkali metal salts are well soluble in water.

The mixing ratio between the aqueous solution and the LWP-based feedstock (water-oil-ratio) in the heat treatment step is preferably in the range of from 0.1 to 1.4 by weight, preferably in the range of 0.2 to 1.0, such as 0.2 to 0.7. Within these mixing ratios, efficient processing can be assured, i.e. providing good purification without excessively producing waste water. In this respect, the mixing ratio “by weight” (wt/wt) means total weight of aqueous solution divided by total weight of LWP-based feedstock. In a continuous process the mixing ratio refers to the flow ratio (by weight) of the respective compounds.

The phase separation (after HT processing) is preferably carried out at a temperature which is sufficiently high to suppress occurrence of a solid-like intermediate phase. In the process of the present invention, the inventors found that a solid-like intermediate phase is sometimes formed in the phase separation step. This solid-like phase impairs separation efficiency and may lead to oil product loss. The inventors, however, surprisingly found that the solid-like phase may be completely dissolved (more specifically separated into oil phase and water phase) by increasing the temperature and that this solid-like phase mainly contains oil phase (i.e. pre-purified LWP). In large scale, even small amounts of solid-like phase can result in significant loss of product. Based on the inventors' findings, the occurrence of the solid-like phase can be avoided by appropriate control of the separation temperature. In a continuous process, the solid-like phase may also be withdrawn via an intermediate outflow channel, the temperature thereof may be increased and the thus phase-separated solid-like phase may be introduced into the same separator (after temperature adjustment) or into a further separator operating at higher temperature. Specific measures for implementing the idea of the invention can be accomplished by the skilled person. Nevertheless, the inventors found that phase separation temperature of 40° C. or more is usually suited to avoid formation of a solid-like phase and is thus favoured. Particularly, it is favoured that the temperature within the separator (e.g. decanter) does not drop below 40° C. in the course of the separation. A particularly preferred temperature range is from 40° C. to 150° C., in the range from 50° C. to 150° C., or in the range from 60° C. to 150° C.

Furthermore, it is preferred that the temperature of the reaction mixture from HT processing (the heat treated effluent) does not drop below 40° C. (preferably not below 50° C. or not below 60° C.), neither before nor during phase separation. That is, the HT processing is carried out at high temperature as said above. Usually, the heat treated effluent is cooled down so as to facilitate phase separation. However, it is preferred that the heat treated effluent is not cooled down (or allowed to cool down) below the above-mentioned temperature before being subjected to phase separation (and also not during phase separation). Thus, formation of a solid-like phase can efficiently be prevented.

In a further aspect, the present invention relates to a method comprising providing a liquefied waste plastic (LWP)-based feedstock, subjecting the liquefied waste plastic (LWP)-based feedstock to heat treatment (HT processing) together with an aqueous solution comprising an alkali metal hydroxide and/or alkaline earth metal hydroxide, and subjecting the effluent of HT processing to phase separation at a temperature which is sufficiently high to suppress occurrence of a solid-like intermediate phase.

If occurrence of the solid-like phase is observed, increasing the temperature of the separator may take a while, in particular in a continuous process. Thus, the solid-like phase may be withdrawn in the meantime and re-introduced after the temperature has been increased to an appropriate temperature. In an alternative embodiment, the withdrawn solid-like phase may be subjected to separation in a further separator operating at higher temperature than the separator after HT processing. However, as said above, it is more favourable to avoid a temperature drop in the separator(s) (and between HT processing and separator) to below 40° C.

The inventors surprisingly found that the oil (purified LWP) resulting from the solid-like phase does not result in further contamination of the product phase. In other words, it can be concluded that the solid-like phase does not mainly occur due to impurities in the oil phase.

The method (or embodiment) of the present invention may thus further comprise detecting whether a solid-like intermediate phase is formed in the phase separation process, and increasing the separation temperature in the phase separation stage if formation of the solid-like intermediate phase is detected. Alternatively (or in addition) solid-like phase may be withdrawn from the separator(s), heated up and subjected to further separation, optionally after addition of further water/base.

The phase separation may employ a series of multiple separators and/or a series of multiple separation techniques. For example, the following may be employed:
the first of the series of multiple separators is a decanter
the first of the series of multiple separators is a decanter centrifuge or a disc stack centrifuge
a (at least one) separator downstream the first separator is a decanter centrifuge or a disc stack centrifuge
a (at least one) separator downstream the first separator is a coalescer

Specifically, the phase separation may employ, in the following order, a decanter, a centrifugal force-assisted separator and a coalescer.

The phase separation is preferably carried out as a continuous process, since this provides a simpler process, in a smaller facility. Both the HT processing and the phase separation may be carried out as a continuous process.

The aqueous solution comprising the alkali metal hydroxide and/or alkaline earth metal hydroxide (employed in HT processing) preferably comprises at least 50 wt.-% water, preferably at least 70 wt.-% water, more preferably at least 85 wt.-% water, at least 90 wt.-% water or at least 95 wt.-% water. Containing mainly water makes the process easier to implement.

The aqueous solution comprising the alkali metal hydroxide and/or alkaline earth metal hydroxide preferably has a pH of 8.0 or more, preferably 9.0 or more, 10.0 or more, 11.0 or more, 12.0 or more, or 13.0 or more, such as in the range of from 8.0 to 14.0, 9.0 to 13.9, 10.0 to 13.9, 11.0 to 13.9, 12.0 to 13.9, or 13.0 to 13.9.

The HT processing is preferably carried out at a temperature of 150° C. or more, preferably 190° C. or more, such as 200° C. or more, 220° C. or more, 240° C. or more or 260° C. or more. The HT processing is preferably carried out at a temperature of 450° C. or less, preferably 400° C. or less, 350° C. or less, or 300° C. or less. For example, the HT processing is carried out at a temperature in the range of 150° C. to 400° C., preferably 200° C. to 350° C., 220° C. to 330° C., 240° C. to 320° C., or 260° C. to 300° C. Such high temperature during HT processing, together with high pH, improves impurity removal efficiency since it allows even removal of organic-bound impurities, such as organic chlorine compounds or organic silicon compounds.

The LWP-based feedstock may be a fraction of liquefied waste plastics or crude liquefied waste plastics. In particular, the LWP-based feedstock may have a 5% boiling point of 25° C., preferably 30° C. or more, 35° C. or more, such as in the range of from 25° C. to 120° C., in the range of from 25° C. to 100° C., in the range of 30° C. to 90° C., or in the range of from 35° C. to 80° C. The liquefied waste plastics (LWP)-based feedstock may have a 95% boiling point of 700° C. or less, preferably 650° C. or less, 600° C. or less, or 550° C. or less, such as in the range of from 180° C. to 700° C., 250° C. to 700° C., 300° C. to 650° C., 350° C. to 600° C., 380° C. to 500° C., or 400° C. to 500° C. The 5% and 95% boiling points of the LWP material (feedstock) may be determined in accordance with ASTM D2887-16.

The step of providing the LWP-based feedstock may include a step of liquefying waste plastics, preferably by thermal degradation of waste plastics, such as pyrolysis or hydrothermal liquefaction or similar process steps. The liquefying may be carried out by any known method such as pyrolysis, including fast pyrolysis, hydropyrolysis and hydrothermal liquefaction.

The step of providing the LWP-based feedstock may include a step of liquefying sorted waste plastics, wherein the method further comprises a step of sorting waste plastics to provide the sorted waste plastics. In this step of sorting waste plastic, preferably at least 50 wt.-%, more preferably at least 55 wt.-%, at least 60 wt.-%, at least 65 wt.-%, at least 70 wt.-%, at least 75 wt.-%, at least 80 wt.-%, or at least 85 wt.-% of chlorine-containing waste plastics, such as polyvinyl chloride, PVC (relative to the original content of chlorine-containing waste plastic, such as PVC, in the waste plastics) are removed from the waste plastics.

The LWP-based feedstock preferably has a density, as measured at 15° C. in the range of from 0.780 to 0.950 kg/l (kg/dm3), such as in the range of from 0.780 to 0.900 kg/l, or in the range of from 0.780 to 0.850 kg/l.

The LWP-based feedstock may have an olefins content of 5 wt.-% or more, such as 10 wt,. % or more, 15 wt.-% or more, 20 wt.-% or more, 30 wt.-% or more, 40 wt.-% or more, or 50 wt.-% or more. The olefins content may for example be 85 wt.-% or less, 80 wt.-% or less, 70 wt.-% or less, or 65 wt.-% or less.

The chlorine content of the LWP-based feedstock may be in the range of from 1 wt.-ppm to 4000 wt.-ppm, such as 100 wt.-ppm to 4000 wt.-ppm, or 300 wt.-ppm to 4000 wt.-ppm. That is, the method of the present invention is suited to process LWP material having a broad concentration range of chlorine impurities.

Preferably, no hydrogen is added in the HT processing and/or no hydrotreating catalyst is present. That is, the pre-treatment step preferably does not comprise or essentially consist of a hydrotreatment process in which the impurities are removed by hydrotreatment e.g. as HCl in the case of chlorine, or resulting in saturation of olefins. At least one of hydrogen and hydrotreatment catalyst is absent in the pre-treatment step (at least at the same time), more preferably both are absent.

That is, although hydrotreatment, in particular hydrogenation, can be favourable, such a procedure is less sustainable because of significant hydrogen gas consumption which is usually produced from fossil sources and/or with significant amounts of energy. More preferably, no hydrogen gas (including dissolved hydrogen gas) is present during the HT processing. In other words, the HT processing is preferably a simple (continuous or batch-wise) process of heat treating the LWP-based feedstock together with the aqueous solution at elevated temperature.

In the present invention, it is preferable that the ratio between the bromine number (BN2) of the treated LWP and the bromine number (BN1) of the LWP-based feedstock, BN2/BN1 is 0.90 or more, preferably 0.95 or more, such as in the range of from 0.90 to 1.10, 0.90 to 1.02, or 0.95 to 1.00. In the present invention, the bromine number can be determined in accordance with ASTM D1159-07 (2017).

### EXAMPLES

The present invention is illustrated by Examples to better help understanding the invention. Although the Examples provide embodiments of the invention, the Examples shall not be used to narrow down the interpretation of the claims. Nevertheless, numerical values disclosed in the Examples may be combined with numerical values or ranges from the remaining description to give combined ranges.

### Example 1

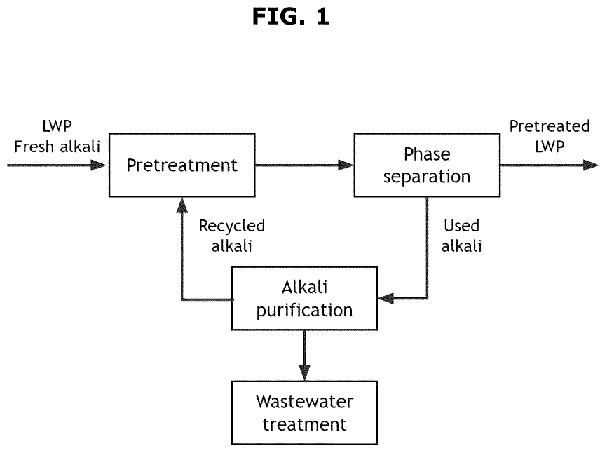

A procedure as shown in FIG. 1 is carried out.

A liquefied waste plastic-based feedstock having a density of 0.9 kg/l was subjected to HT processing (Pretreatment in FIG. 1) with a 2 wt.-% NaOH aqueous solution (pH 13.7) at a water-oil-ratio of 0.3 (15 wt.-parts/h aqueous solution to 50 wt.-parts/h LWP-based feedstock) at a temperature of 260° C. in a continuous process at a residence time at 260° C. being 20 minutes.

The resulting reaction mixture was subjected to phase separation in a decanter (phase separation in FIG. 1) to give a treated LWP material (about 49 wt.-parts/h) and an aqueous phase (about 16 wt.-parts/h; “Used alkali” in FIG. 1). The aqueous phase contained approximately 1.7 wt.-% NaOH in addition to reactants (such as NaCl) and organic impurities (TOC about 70000 mg/l).

The aqueous phase was subjected to filtration (Alkali purification in FIG. 1). Specifically, the aqueous phase was first filtered over a 15 μm mesh opening filter (mechanical filtration; Microdyn Nadir MP005) to remove solids, followed by separation of organic components and from the aqueous phase by filtration with a 200 Dalton cut-off membrane. In this Example, AMS NanoPro B-4022 membrane was used and provided a TOC rejection about 80% into retentate.

Filtration was carried out as a continuous process as well.

It was surprisingly found that enough filterability could be obtained by filtration directly through 200 Dalton membrane with mechanical pre-filtration.

The membrane filtration permeate (9.9. wt.-parts/h; Recycled alkali in FIG. 1) was fed back to HT processing after being adjusted to a NaOH content of 2 wt.-% by use of a stock solution (20 wt.-% NaOH) and fresh water so as to achieve a recycle rate of about 66% (9.9/15) (not shown in FIG. 1).

The retentate was subjected to “Wastewater treatment” comprising (continuous) evaporation to give a waste water evaporate and a residue having high contraction of organics and NaOH. The collected residue was then burned.

### Example 2

Example 2 was carried out under the same conditions as Example 1, except for adding a further filtration step between mechanical filtration and membrane filtration. The further filtration step was carried out as a microfiltration step with a Nadir NPO30 (500 Dalton rejection size).

This Example provided higher filtration efficiency than Example 1, i.e. an extra lean TOC retentate flow. Specifically, the further filtration resulted in 10% reduction of TOC and the membrane filtration resulted in further 80% reduction (relative to original content—overall reduction thus 90%). However, the total ‘retentate flow:feed flow’-ratio was increased, thus reducing alkali recycling amount and increasing retentate amount. Since the retentate is further worked up using evaporation, the overall energy consumption of the process increased.

### Example 3

Example 3 was carried out under the same conditions as Example 1, except for using a NanoPro S3012 (200 Dalton rejection size), which yielded essentially the same results as Example 1.

### Example 4

The same liquefied waste plastic-based feedstock as in Example 1 was subjected to HT processing with a 2 wt.-% NaOH aqueous solution (pH 13.7) at a water-oil-ratio of 0.3 (15 wt.-parts/h aqueous solution to 50 wt.-parts/h LWP-based feedstock) at a temperature of 260° C. in a continuous process at a residence time at 260° C. being 20 minutes.

The resulting reaction mixture was subjected to phase separation in a decanter to give a treated LWP material (about 49 wt.-parts/h) and an aqueous phase (about 16 wt.-parts/h). The aqueous phase contained approximately 1.7 wt.-% NaOH in addition to reactants (such as NaCl) and organic impurities (TOC about 70000 mg/l).

The aqueous phase was split up into two streams and the first stream (i.e. a part of the aqueous phase) representing about 50 wt.-% of the aqueous phase (about 8 wt.-parts/h) was recycled back to HT processing after addition of fresh water (waste water evaporate mentioned below) and fresh NaOH from a stock solution (20 wt.-% NaOH) such that the resulting aqueous solution had a pH of 13.7 (2.0 wt.-% NaOH concentration).

The remainder of the aqueous phase, i.e. the second stream (about 8 wt.-parts/h), was subjected to evaporation to provide a waste water evaporate and an evaporation residue. The evaporation residue was sent to combustion (which required addition of a fuel), the waste water evaporate was partly fed back to the HT processing as a fresh water (i.e. not counting as aqueous phase recycling) and the remainder was sent to conventional waste water treatment.

1.-14. (canceled)

15. Method for processing of liquefied waste plastics (LWP), said method comprising:
subjecting a liquefied waste plastic-based feedstock to heat treatment (HT processing) in an aqueous solution including alkali metal hydroxide and/or alkaline earth metal hydroxide to form a heat treated effluent;
transferring the heat treated effluent to a separator;
subjecting said heat treated effluent to phase separation to isolate at least an oil phase including treated LWP and an aqueous phase including contaminated material; and
recycling at least a part of the aqueous phase back to the HT processing.

16. The method according to claim 15, comprising:
subjecting the aqueous phase to a treatment to form an organics-rich stream and an organics-depleted stream, wherein the organic-depleted stream is recycled back to the HT processing.

17. The method according to claim 15, wherein 1 wt.-% to 90 wt.-% of the aqueous phase is recycled back to the HT processing.

18. The method according to claim 17, wherein 5 wt.-% to 85 wt.-%, and/or 10 wt.-% to 80 wt.-%, 15 wt.-% to 75 wt.-%, 20 wt.-% to 70 wt.-%, 25 wt.-% to 70 wt.-%, 30 wt.-% to 65 wt.-%, and/or 40 wt.-% to 60 wt.-% of the aqueous phase is recycled back to the HT processing.

19. The method according to claim 15, comprising:
subjecting part of the aqueous phase to evaporation to provide an evaporation residue and a waste water evaporate.

20. The method according to claim 15, comprising:
adding fresh alkali metal hydroxide solution and/or alkaline earth metal hydroxide solution to the recycled aqueous phase to form a combined stream before feeding it back to the HT processing.

21. The method according to claim 15, comprising:
adjusting a pH of the aqueous phase to pH 9 or more, and/or pH 10 or more, pH 11 or more, and/or pH 11.5 or more, before recycling it back to the HT processing.

22. The method according to claim 15, wherein the aqueous solution containing the alkali metal hydroxide and/or alkaline earth metal hydroxide which is subjected to heat treatment (HT processing), together with a liquefied waste plastic (LWP)-based feedstock, contains the alkali metal hydroxide and/or alkaline earth metal hydroxide in an amount in a range of from 0.5 wt.-% to 10.0 wt.-%, and/or from 1.0 wt.-% to 6.0 wt.-%, or 1.5 wt.-% to 4.0 wt.-%.

23. The method according to claim 15, wherein a mixing ratio (water-oil-ratio) between the aqueous solution and a LWP-based feedstock in the heat treatment is in a range of from 0.1 to 1.4 by weight, and/or in a range of 0.2 to 1.0, and/or 0.2 to 0.7.

24. The method according to claim 15, comprising:
carrying out the phase separation as a continuous process.

25. The method according to claim 15, comprising:
carrying out the phase separation at a temperature in a range of from 40° C. to 150° C., and/or in a range from 50° C. to 150° C., and/or in a range from 60° C. to 150° C.

26. The method according to claim 15, comprising:
subjecting the aqueous phase to a process including filtration, and/or including membrane filtration, to provide a retentate enriched in total organic carbon (TOC) and a permeate depleted in total organic carbon (TOC), and including alkali metal hydroxide and/or alkaline earth metal hydroxide; and
recycling the permeate, after optional further purification, back to the HT processing as the at least part of the aqueous phase.

27. The method according to claim 15, comprising:
carrying out the HT processing at a temperature of 150° C. or more, and/or 190° C. or more, 200° C. or more, 210° C. or more, 220° C. or more, 240° C. or more, and/or 260° C. or more.

28. The method according to claim 15, comprising:
carrying out the HT processing at a temperature of 450° C. or less, and/or 400° C. or less, 350° C. or less, 320° C. or less, and/or 300° C. or less.
